(19) United States
(12) Patent Application Publication
(10) Pub. No.: US 2010/0098842 A1
(43) Pub. Date: Apr. 22, 2010

(54) PROCESS FOR CORROSION-PROOFING METALLIC SUBSTRATES

(75) Inventor: Michael Dornbusch, Luedenscheid (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/531,210

(22) PCT Filed: Dec. 13, 2007
(86) PCT No.: PCT/EP2007/010945

§ 371 Date: Sep. 14, 2009

(30) Foreign Application Priority Data
Mar. 15, 2007 (DE) 102007012406.8

(51) Int. Cl. B05D 5/12

(52) U.S. Cl. 427/123

(57) ABSTRACT

The invention relates to a process for corrosion-proofing metallic substrates that involves in a first stage (I) coating the substrate by electroless immersion into an aqueous bath of an anticorrosion agent K1 with a pH of between 1 and 5, comprising at least one compound having as its cation a lanthanide metal and/or a d-block element metal, bar chromium, and/or having as its anion a d-block element metallate, bar chromium-containing metallates, and at least one oxidation-capable acid, bar phosphorus and/or chromium acids, a conversion being effected on the substrate surface, and in a concluding stage (III) carrying out further coating by deposition of a cathodic electrocoat material.

Processes and coating compositions for the electroless anticorrosion coating of various metal substrates, in particular by means of autophoretic deposition coating, are known. They offer the advantage of a simpler, less expensive, and less time-consuming operation. In particular, the electroless processes allow cavities in and edges on the target substrates to be coated more effectively than with processes which require the application of a voltage.

In more recent times, one of the goals of development has been chrome-free autophoretic coating compositions which ensure very effective corrosion control, comparable with that provided by chromium-containing coating compositions. In the course of this development work, coating compositions comprising salts of the lanthanide elements and of the d-block elements, plus an organic film-forming component, have emerged as being particularly suitable.

The autophoretic coating compositions described for example in WO-A-99/29927, WO-A-96/10461, and DE-A-37 27 382, however, have as disadvantages the tendency of the metal ions formed from the substrate to migrate through the deposited anticorrosion coat, and also the use of environmentally controversial substances, particularly fluorides.

DE-A-10 2005 023 728 and DE-A-10 2005 023 729 describe coating compositions which offer outstanding solutions to the aforementioned problems of metal ion migration and of the use of environmentally controversial substances. In particular, the two-stage process DE-A-10 2005 023 728 describes for the corrosion-proofing of metallic substrates, in whose first stage the substrate is immersed into a bath of an anticorrosion agent K, which effects a conversion on the substrate surface, and in whose second stage the substrate treated in stage (a) is immersed in a bath in aqueous coating composition comprising a water-dispersible and/or water-soluble polymer P having covalently bonded ligands which form chelates with the substrate surface and/or with the metal ions liberated in the course of the corrosion of the substrate, and also having crosslinking functional groups B which are able to form covalent bond to crosslinkers V with themselves, with further, complementary functional groups B′ of the polymer P and/or with further functional groups B and/or B′, has proven particularly suitable.

For specialty applications, however, particularly in automotive engineering, the anticorrosion coatings on a purely autophoretic basis have proven not to be adequate, since the corrosion control, in particular after impact stress, is unable fully to satisfy the exacting requirements.

Described in WO-A-01/46495 is the combination of a 2-stage pretreatment of metal substrates, which comprises in the first stage a pretreatment with a coating composition comprising a compound of elements of group IIIb, IVb and/or lanthanides, and in a second stage the pretreatment with a coating composition comprising a reaction product of an epoxy-functional compound with phosphorus, amine and/or sulfur compounds, with a subsequent lead-free electrodeposition coating. The coating produced in this way is said to combine effective corrosion control with a high degree of eco-friendliness. In the first pretreatment stage, however, preference is given to the use of fluorine compounds, which are environmentally controversial.

### PROBLEM AND SOLUTION

In the light of the abovementioned prior art, the problem addressed by the invention was that of finding a largely environmentally unobjectionable process for corrosion-proofing, particularly in the automobile segment, which can be applied by means of an easily technically accomplishable operation to the substrate that is to be protected. The process ought in particular to be accomplishable without substances containing fluoride. Moreover, the process of the invention ought in particular to lead to anticorrosion coats which largely prevent the migration of the metal ions formed from the substrate, and which are deposited effectively on and in the substrate's edges and cavities. A further intention was to minimize the effect of extraneous metal ions and to achieve effective corrosion control for a comparatively low level of material employed. The process, moreover, was to provide anticorrosion coats which develop effective protection for as many different metal substrates as possible, and which are largely independent of the redox potential of the substrate that is to be coated.

In the light of the aforementioned problems, surprisingly, a process has been found for corrosion-proofing metallic substrates, comprising as its first stage (I) electroless pretreatment of an aqueous anticorrosion agent K1 comprising at least one compound (A1) having as its cation a lanthanide metal and/or a d-block element metal, bar chromium, and/or having as its anion a d-block element metallate, bar chromium-containing metallates, and also (A2) at least one oxidation-capable acid, bar phosphorus and/or chromium acids; preferably, as a second stage (II), a further electroless pretreatment with an aqueous anticorrosion agent K2, comprising a water-dispersible and/or water-soluble polymer P having covalently bonded ligands L which form chelates with the substrate surface and/or with the metal ions liberated in the course of the corrosion of the substrate, and also having crosslinking functional groups B which are able to form covalent bonds to crosslinkers V with themselves, with further functional groups B′ of the polymer P and/or with further functional groups B and/or B′; and also, as a concluding stage (III), a further coating by deposition of an electrocoat material.

### DESCRIPTION OF THE INVENTION

### The First Stage (I) of the Process of the Invention

In the first stage (I) of the process of the invention the aqueous anticorrosion agent K1 described below is applied electrolessly to the metallic substrate. Electrolessly here means the absence of electrical currents as a result of application of voltage.

Prior to the application of the aqueous anticorrosion agent K1, the substrate, in one preferred embodiment of the invention, is cleaned, in particular of oily and fatty residues, using preferably detergents and/or alkaline cleaners. In a further preferred embodiment of the invention, cleaning with detergents and/or alkaline cleaners is followed, but still before application of the coating composition of the invention, by rinsing with water. For the purpose of removing deposits and/or chemically modified, especially oxidized, layers on the surface of the substrate, it is possible, in one further preferred embodiment of the invention, to precede the rinsing step by mechanical cleaning of the surface, using abrasive media for example, and/or by chemical removal of the surface layers, using deoxidizing cleaners, for example.

The aqueous anticorrosion agent K1 has a pH of between 1 and 5 and comprises at least one compound (A1) having as its cation a lanthanide metal and/or a d-block element metal, bar chromium, and/or as its anion a d-block element metallate, bar chromium-containing metallates, and also (A2) at least one oxidation-capable acid, bar phosphorus and/or chromium acids.

The solubility of the compound (A1) in water is preferably very good. Particular preference is given to compounds (A1) [cation]n[anion]m (with n,m>=1) having a solubility product SP=[cation]ⁿ*[anion]^{m}>10⁻⁸* mol^{(n+m)}/l^{(n+m)}, very particular preference to compounds (A1) having a solubility product SP>10⁻⁶* mol^{(n+m)}/l^{(n+m)}. In one especially preferred embodiment of the invention the concentration of the compounds (A1) in the anticorrosion agent is 10⁻¹ to 10⁻⁴ mol/l, in particular 5*10⁻¹ to 10⁻³ mol/l.

As its cationic constituent the compound (A1) may include lanthanide metal cations and/or d-block metal cations. Preferred lanthanide metal cations are lanthanum, cerium, praseodymium, neodymium, promethium, samarium, europium and/or dysprosium cations. Lanthanum, cerium, and praseodymium cations are especially preferred. The lanthanide metal cations may be in a mono-, di- and/or trivalent oxidation state, the trivalent oxidation state being preferred. Preferred d-block metal cations are titanium, vanadium, manganese, yttrium, zirconium, niobium, molybdenum, tungsten, cobalt, ruthenium, rhodium, palladium, osmium and/or iridium cations. Barred as a d-block element cation is the chromium cation, in any oxidation state. Vanadium, manganese, tungsten, molybdenum and/or yttrium cations are especially preferred. The d-block element cations may be present in a mono- to hexavalent oxidation state, preference being given to a trivalent to hexavalent oxidation state.

The anions which, with the lanthanide metal cations and/or d-block element cations, form the compounds (A1) are preferably selected in such a way that the aforementioned conditions for the solubility product SP are met. Preference is given to anions of oxidizing acids of the elements of transition group VI, VII, and VIII of the periodic table of the elements, and also to anions of oxidizing acids of the elements of main group V and VI of the periodic table of the elements, barring anions of oxidizing acids of phosphorus and chromium; preference is given to using nitrates, nitrites, sulfites and/or sulfates. Further possible anions are halides, bar fluorides.

In a further preferred embodiment of the invention the lanthanide metal cations and/or d-block element cations of the compounds (A1) may also take the form of complexes with unidentate and/or multidentate, potentially anionic ligands. Preferred ligands are unfunctionalized or functionalized terpyridines, unfunctionalized or functionalized ureas and/or thioureas, unfunctionalized or functionalized amines and/or polyamines, such as EDTA in particular, imines, such as, in particular, imine-functionalized pyridines, organosulfur compounds, such as, in particular, unfunctionalized or functionalized thiols, thiocarboxylic acids, thioaldehydes, thioketones, dithiocarbamates, sulfonamides, thioamides, and, with particular preference, sulfonates, unfunctionalized or functionalized organoboron compounds, such as boric esters in particular, unfunctionalized or functionalized polyalcohols, such as, in particular, carbohydrates and their derivatives and also chitosans, unfunctionalized or functionalized acids, such as, in particular, difunctional and/or oligofunctional acids, unfunctionalized or functionalized carbenes, acetylacetonates, unfunctionalized or functionalized acetylenes, unfunctionalized or functionalized carboxylic acids, such as, in particular, carboxylic acids which can be attached ionically and/or coordinatively to metal centers, and also phytic acid and derivatives thereof.

Very particular preference is given as ligands to phytic acid, derivatives thereof, and sulfonates, which are unfunctionalized or functionalized.

In one particularly preferred embodiment of the invention the compounds (A1) comprise as their anions d-block element metallates which are able, together with the d-block element cations or else on their own, to form the compound (A1). Preferred d-block elements for the metallates are vanadium, manganese, zirconium, niobium, molybdenum and/or tungsten. Vanadium, manganese, tungsten and/or molybdenum are especially preferred. Barred from consideration as d-block element metallates are chromates, in any oxidation states. Particularly preferred d-block element metallates are oxo anions, such as, in particular, tungstates, permanganates, vanadates and/or molybdates. Where the d-block element metallates form the compound (A1) on their own, in other words without lanthanide metal cations and/or d-block metal cations, the preferred solubility product SP of such compounds is subject to the remarks made above. Preferred cations of such compounds (A1) are sulfonium ions, phosphonium ions and/or ammonium ions, with or without substitution by organic radicals, alkali metal cations, such as, in particular, lithium, sodium and/or potassium, and alkaline earth metal cations, such as, in particular, magnesium and/or calcium. Particular preference is given to the ammonium ions, with or without substitution by organic radicals, and the alkali metal cations, which ensure a particularly high solubility product SP of the compound (A1).

As component (A2) of the anticorrosion agent K1 at least one oxidation-capable acid is used such that the pH of the anticorrosion agent is between 1 and 5, preferably between 2 and 4. Preferred acids (A2) are selected from the group consisting of oxidizing mineral acids, such as, in particular, nitric acid, nitrous acid, sulfuric acid and/or sulfurous acid. To adjust the pH it is possible where necessary to use a buffer medium, such as, for example, salts of moderately strong bases and weak acids, such as, in particular, ammonium acetate.

The continuous phase used for the anticorrosion agent K1 is water, preferably deionized and/or distilled water.

The substrate pretreated as above is contacted with the anticorrosion agent K1. This is preferably done by immersing or drawing the substrate in or through a bath containing the anticorrosion agent K1. The residence times of the substrate in the anticorrosion agent K1 are preferably 1 second to 10 minutes, more preferably 10 seconds to 8 minutes, and with particular preference 30 seconds to 6 minutes. The temperature of the bath containing the anticorrosion agent K1 is preferably between 25 and 90° C., more preferably between 30 and 80° C., with particular preference between 35 and 70° C.

The wet film thickness of the coat produced with the coating composition K1, after autophoretic application, is between 5 and 900 nm, preferably between 15 and 750 nm, more preferably between 25 and 600 nm.

Treatment of the substrate with the coating composition K1 may be followed, prior to the concluding electrodeposition coating, by drying of the coat of the coating composition K1 at temperatures between about 30 and 200° C., in particular between 100 and 180° C., for which the drying apparatus can be regarded as largely uncritical to the advantageous action of the coating composition of the invention.

With particular preference the coat of coating composition K1, prior to the concluding electrodeposition coating and, where appropriate, prior to the preferred application of the anticorrosion agent K2, is flashed off—in other words, exposed to temperatures between 25 and 120° C., preferably between 30 and 90° C., for a period of 30 seconds to 30 minutes, preferably for a period of 1 minute to 25 minutes.

### The Preferred Second Stage (II) of the Process of the Invention

The aqueous anticorrosion agent K2 of the invention, which in one preferred embodiment of the invention is applied to the coat of anticorrosion agent K1 applied in the first stage (I) of the process of the invention, comprises polymers P which carry ligands L which form chelates with the metal ions released in the course of the corrosion of the substrate, and which carry crosslinking functional groups B which are able to form covalent bonds with themselves and/or with further functional groups B′, which where appropriate may be part of additional crosslinkers V.

In the sense of the invention, water-dispersible or water-soluble means that the polymers P in the aqueous phase form aggregates having an average particle diameter of <50, preferably <35 nm and more preferably <20 nanometers, or are in molecularly disperse solution. Consequently, such aggregates differ fundamentally in their average particle diameter from dispersion particles of the kind described for example in DE-A-37 27 382 or WO-A-96/10461. Polymers P in molecularly disperse solution generally have molecular weights of <100 000, preferably <50 000, more preferably <20 000 daltons. The size of the aggregates consisting of polymer P is brought about in a manner known per se through the introduction of hydrophilic groups HG on the polymer P. The number of hydrophilic groups HG on the polymer P depends on the solvation capacity and on the steric accessibility of the groups HG and may likewise be adjusted by the skilled worker in a manner known per se. Preferred hydrophilic groups HG on the polymer P are ionic groups such as, in particular, sulfate, sulfonate, sulfonium, phosphate, phosphonate, phosphonium, ammonium and/or carboxylate groups, and also nonionic groups, such as, in particular, hydroxyl, primary, secondary and or tertiary amine, and amide groups and/or oligoalkoxy or polyalkoxy substituents, such as, preferably, ethoxylated or propoxylated substituents, which may be etherified with further groups. The hydrophilic groups HG may be identical with the ligands L and/or crosslinking functional groups B and/or B′ that are described below.

The number of hydrophilic groups HG on the polymer P depends on the solvation capacity and on the steric accessibility of the groups HG and may likewise be adjusted by the skilled worker in a manner known per se.

In a further preferred embodiment of the invention the above-mentioned hydrophilic groups HG form a gradient in their concentration along the polymer backbone. The gradient is defined by a slope in the spatial concentration of the hydrophilic groups along the polymer backbone. Polymers P with a construction of this kind are capable of forming micelles in the aqueous medium, and exhibit a surface activity on the surface of the substrate to be coated; in other words, the interfacial energy of the coating composition of the invention on the surface to be coated is reduced.

The gradient is preferably produced in a manner known per se by the appropriate disposition of monomeric units which make up the polymer and which carry hydrophilic groups and/or groups with which hydrophilic groups HG can be produced.

As the polymer backbone of the polymers P it is possible in general to use any desired polymers, preferably those having molecular weights of 1000 to 50 000 daltons, more preferably with molecular weights of 2000 to 20 000 daltons. As the polymer backbone it is preferred to use polyolefins or poly(meth)acrylates, polyurethanes, polyalkyleneimines, polyvinylamines, polyalkylenamines, polyethers, polyesters, and polyalcohols, which in particular are partly acetalized and/or partly esterified. The polymers P may be linear, branched and/or dendritic in construction. Especially preferred polymer backbones are polyalkyleneimines, polyvinylamines, polyalcohols, poly(meth)acrylates, and hyperbranched polymers, of the kind described for example in WO-A-01/46296.

The polymers P are preferably stable to hydrolysis in the acidic pH range, in particular at pH values <5, with particular preference at pH values <3.

Suitable ligands L are all groups or compounds which can form chelates with the metal ions liberated in the course of the corrosion of the substrate. Preference is given to unidentate and/or multidentate, potentially anionic ligands. Particularly preferred ligands L are
unfunctionalized or functionalized ureas and/or thioureas, especially acylthioureas such as benzoylthiourea, for example,
unfunctionalized or functionalized amines and/or polyamines, such as EDTA in particular,
unfunctionalized or functionalized amides, especially carboxamides,
imines and imides, such as imine-functionalized pyridines in particular,
oximes, preferably 1,2-dioximes such as functionalized diacetyldioxime,
organosulfur compounds, such as, in particular, unfunctionalized or functionalized thiols such as thioethanol, thiocarboxylic acids, thioaldehydes, thioketones, dithiocarbamates, sulfonamides, thioamides and, with particular preference, sulfonates,
organophosphorus compounds, such as, in particular, phosphates, more preferably phosphoric esters of (meth)acrylates, and also phosphonates, more preferably vinylphosphonic acid and hydroxy-, amino-, and amido-functionalized phosphonates,
unfunctionalized or functionalized organoboron compounds, such as boric esters, in particular,
unfunctionalized or functionalized polyalcohols, such as, in particular, carbohydrates and their derivatives, and also chitosans,
unfunctionalized or functionalized acids, such as, in particular, difunctional and/or oligofunctional acids, or unfunctionalized or functionalized (poly)carboxylic acids, such as, in particular, carboxylic acids which can be attached ionically and/or coordinatively to metal centers, preferably (poly)methacrylates having acid groups, or difunctional or oligofunctional acids,
unfunctionalized or functionalized carbenes,
acetylacetonates,
unfunctionalized or functionalized acetylenes,
and phytic acid and derivatives thereof.

Suitable crosslinking functional groups B on the polymer P are those which are able to form covalent bonds with themselves and/or with complementary functional groups B′. The covalent bonds are preferably formed thermally and/or by exposure to radiation. With particular preference the covalent bonds are formed thermally. The crosslinking functional groups B and B′ bring about the formation of an intermolecular network between the molecules of the polymer P.

Functional groups B and/or B′ that crosslink on exposure to radiation contain activable bonds, such as single or double carbon-hydrogen, carbon-carbon, carbon-oxygen, carbon-nitrogen, carbon-phosphorus or carbon-silicon bonds. In this context, carbon-carbon double bonds are particularly advantageous. Especially suitable carbon-carbon double bonds as groups B are
with particular preference (meth)acrylate groups
ethyl acrylate groups
vinyl ether and vinyl ester groups
crotonate and cinnamate groups
allyl groups
dicyclopentadienyl groups
norbornyl and isoprenyl groups
isopropenyl or butenyl groups.

Thermally crosslinking functional groups B can form covalent bonds with themselves or, preferably, with complementary crosslinking functional groups B′ when exposed to thermal energy.

Especially suitable thermally crosslinking functional groups B and B′ are
with particular preference hydroxyl groups,
mercapto and amino groups,
aldehyde groups,
azide groups,
acid groups, especially carboxylic acid groups,
acid anhydride groups, especially carboxylic anhydride groups,
acid ester groups, especially carboxylic ester groups,
ether groups,
with particular preference carbamate groups,
urea groups,
epoxide groups,
with particular preference isocyanate groups, which with very particular preference have been reacted with blocking agents which undergo deblocking at the baking temperatures of the coating compositions of the invention, and/or are incorporated without deblocking into the network which forms.

Particularly preferred combinations of thermally crosslinking groups B and complementary groups B′ are the following:
hydroxyl groups with isocyanate and/or carbamate groups,
amino groups with isocyanate and/or carbamate groups,
carboxylic acid groups with epoxide groups.

Particularly preferred polymers P with a gradient of the hydrophilic groups along the polymer backbone comprise copolymers PM, preparable by single-stage or multistage free-radical copolymerization in an aqueous medium of
a) olefinically unsaturated monomers (a1) and (a2), (a1) comprising in each case at least one monomer from the group consisting of olefinically unsaturated monomers (a11) having at least one hydrophilic group HG, olefinically unsaturated monomers (a12) having at least one ligand group L, and olefinically unsaturated monomers (a13) having at least one crosslinking group B,
and
b) at least one olefinically unsaturated monomer other than the olefinically unsaturated monomers (a1) and (a2), of the general formula I

R¹R²C═CR³R⁴ (I),
in which the radicals R¹, R², R³, and R⁴ each independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals.

Suitable hydrophilic monomers (a11) contain at least one hydrophilic group (HG) which, as described above, is selected preferably from the group consisting of sulfate, sulfonate, sulfonium, phosphate, phosphonate, phosphonium, ammonium and/or carboxylate groups and also hydroxyl, primary, secondary and/or tertiary amine groups and amide groups, and/or oligoalkoxy or polyalkoxy substituents, such as, preferably, ethoxylated or propoxylated substituents, which may be etherified with further groups.

Examples of highly suitable hydrophilic monomers (a11) are acrylic acid, methacrylic acid, ethacrylic acid, crotonic acid, maleic acid, fumaric acid or itaconic acid and salts thereof, preferably acrylic acid and methacrylic acid, olefinically unsaturated sulfonic, sulfuric, phosphoric or phosphonic acids, their salts and/or their partial esters. Also highly suitable are olefinically unsaturated sulfonium and phosphonium compounds. Also highly suitable are monomers (a11) which carry at least one hydroxyl group or hydroxymethylamino group per molecule and are substantially free from acid groups, such as, in particular, hydroxy alkyl esters of alpha,beta-olefinically unsaturated carboxylic acids, such as hydroxyalkyl esters of acrylic acid, methacrylic acid, and ethacrylic acid in which the hydroxyalkyl group contains up to 20 carbon atoms, such as, preferably, 2-hydroxyethyl, 2-hydroxypropyl, 3-hydroxypropyl, 3-hydroxybutyl, and 4-hydroxybutyl acrylate and methacrylate, formaldehyde adducts of aminoalkyl esters of alpha,beta-olefinically unsaturated carboxylic acids and of alpha,beta-unsaturated carboxamides, such as N-methylol- and N,N-dimethylol-aminoethyl acrylate, -aminoethyl methacrylate, -acrylamide, and -methacrylamide. Suitable monomers (a1) containing amine groups include the following: 2-aminoethyl acrylate and methacrylate, N-methyl- and N,N-dimethyl-aminoethyl acrylate, or allylamine. Monomers (a11) used that contain amide groups are preferably amides of alpha,beta-olefinically unsaturated carboxylic acids, such as (meth)acrylamide, preferably N-methyl- or N,N-dimethyl(meth)acrylamide. Ethoxylated or propoxylated monomers (a11) used are preferably acrylic and/or methacrylic esters of polyethylene oxide and/or polypropylene oxide units, whose chain length is preferably between 2 and 20 ethylene oxide or propylene oxide units.

In the selection of the hydrophilic monomers (a11) it should be ensured that the formation of insoluble salts and polyelectrolyte complexes is avoided.

Examples of highly suitable monomers (a12) are olefinically unsaturated monomers which contain the above-described ligands L as substituents. Examples of suitable monomers (a12) are esters and/or the amides of acrylic acid, methacrylic acid, ethacrylic acid, crotonic acid, maleic acid, fumaric acid or itaconic acid, particularly of acrylic and/or of methacrylic acid, which contain the ligands L in the ester radical and/or amide radical. Ligands L are preferably unfunctionalized or functionalized urea and/or thiourea substituents, unfunctionalized or functionalized amine and/or polyamine substituents, imine and imide substituents, such as, in particular, imine-functionalized pyridines, oxime substituents, preferably 1,2-dioximes such as functionalized diacetyldioxime, organosulfur substituents, such as, in particular, those derivable from unfunctionalized or functionalized thiols such as thioethanol, thiocarboxylic acids, thioaldehydes, thioketones, dithiocarbamates, sulfonamides, thioamides, and, with particular preference, sulfonates, organophosphorous substituents, such as, in particular, those derivable from phosphates, more preferably phosphoric esters of (meth)acrylates, and also phosphonates, more preferably vinylphosphonic acids and hydroxy-, amino-, and amido-functionalized phosphonates, unfunctionalized or functionalized organoboron substituents, such as, in particular, those derivable from boric esters, unfunctionalized or functionalized polyalcohol substituents, such as, in particular, those derivable from carbohydrates and derivatives thereof and also chitosans, unfunctionalized or functionalized acid substituents, such as, in particular, those derivable from difunctional and/or oligofunctional acids, or unfunctionalized or functionalized (poly)carboxylic acids, such as, in particular, carboxylic acids which can be attached ionically and/or coordinatively to metal centers, preferably (poly)methacrylates with acid groups, or difunctional or oligofunctional acids, substituents with unfunctionalized or functionalized carbenes, acetylacetonates, unfunctionalized or functionalized acetylenes, and also phytic acids and derivatives thereof.

Examples of highly suitable monomers (a13) are olefinically unsaturated monomers which contain the above-described crosslinking groups B and/or B′ as substituents. Examples of suitable monomers (a13) are esters and/or the amides of acrylic acid, methacrylic acid, ethacrylic acid, crotonic acid, maleic acid, fumaric acid or itaconic acid, particularly of acrylic and/or of methacrylic acid, which contain the crosslinking groups B in the ester radical and/or amide radical. Particularly preferred crosslinking groups B and B′ are hydroxyl groups and also, for example, mercapto and amino groups, aldehyde groups, azide groups, acid groups, especially carboxylic acid groups, acid anhydride groups, especially carboxylic anhydride groups, acid ester groups, especially carboxylic ester groups, ether groups, with particular preference carbamate groups, examples being urea groups, epoxide groups, and also, with particular preference, isocyanate groups, which with very particular preference have been reacted with blocking agents which undergo deblocking at the baking temperatures of the coating compositions of the invention and/or are incorporated, without deblocking, into the network that forms.

The monomers (a11) are disposed in the polymer PM in such a way as to produce the above-described gradient of hydrophilic groups HG along the main polymer chain. This is generally apparent from the specific copolymerization parameters of the different monomers (a11), (a12), (a13), (a2), and (b) in the aqueous reaction medium. The aforementioned monomers (a12) and (a13) are preferably disposed statistically along the main polymer chain. From the above listing of the exemplified monomers (a11), (a12), and (a13) it is apparent that the hydrophilic groups HG, the ligands L, and the crosslinking groups B may be partly or completely identical. In this case, the ligands L and the crosslinking functional groups B also generally exhibit a gradient along the main polymer chain.

Examples of preferred olefinically unsaturated comonomers (a2) are
(1) substantially acid-group-free esters of olefinically unsaturated acids, such as (meth)acrylic, crotonic, ethacrylic, vinylphosphonic or vinylsulfonic alkyl or cycloalkyl esters having up to 20 carbon atoms in the alkyl radical, especially methyl, ethyl, propyl, n-butyl, sec-butyl, hexyl, ethylhexyl, stearyl, and lauryl or cyclohexyl (meth)acrylate;
(2) vinyl esters of alpha-branched monocarboxylic acids having 5 to 18 carbon atoms in the molecule, such as the vinyl esters of Versatic® acid, which are sold under the brand name VeoVa®; and also
(3) vinylaromatic hydrocarbons, such as styrene, vinyltoluene or alpha-alkylstyrenes, especially alpha-methylstyrene.

As regards the preparation of the copolymers PM, reference may be made to the teachings of DE-A-198 58 708, of DE-A-102 06 983, and of DE-A-102 56 226.

Suitable crosslinkers V containing thermally crosslinking and/or radiation-crosslinking groups B and/or B′ are in principle all of the crosslinkers that are known to the skilled worker. Preferred are low molecular weight or oligomeric crosslinkers V, with a molecular weight of <20 000 daltons, more preferably <10 000 daltons. The backbone of the crosslinkers V that carries the crosslinking groups B and/or B′ may be linear, branched and/or hyperbranched in structure. Preference is given to branched and/or hyperbranched structures, particularly those as described for example in WO-A-01/46296.

The crosslinkers V are preferably stable to hydrolysis in the acidic pH range, in particular at pH values <5, more preferably at pH values <3. Particularly preferred crosslinkers V carry the above-described crosslinking groups B and/or B′ which react with the crosslinking groups of the polymer P to form covalent bonds. Especially preferred are crosslinkers V containing thermally-crosslinking and, where appropriate, additionally radiation-crosslinking groups B and/or B′.

In one further particularly preferred embodiment of the invention the crosslinkers V, further to the crosslinking groups B and B′, carry ligands L′ which may be identical with and/or different than the ligands L of the polymer P.

Especially suitable crosslinking functional groups B and B′ for the crosslinkers V are as follows:
in particular, hydroxyl groups,
in particular, aldehyde groups,
azide groups,
acid anhydride groups, especially carboxylic anhydride groups,
carbamate groups,
urea groups,
in particular, isocyanate groups, which with very particular preference have been reacted with blocking agents which undergo deblocking at the baking temperatures of the coating compositions of the invention and/or are incorporated, without deblocking, into the network that forms,
(meth)acrylate groups,
vinyl groups
   or combinations of these.

Of very particular preference as crosslinkers V are branched and/or hyperbranched polyisocyanates which are at least partly blocked and which additionally carry ligands L′.

The continuous phase used for the coating composition K2 is water, preferably deionized and/or distilled water. As a further preferred component, use is made of at least one oxidation-capable acid such that the pH of the coating composition K2 is preferably between 1 and 5, more preferably between 2 and 4. Particularly preferred acids are selected from the group consisting of oxidizing mineral acids, such as, in particular, nitric acid, nitrous acid, sulfuric acid and/or sulfurous acid. In order to adjust the pH it is possible where necessary to use a buffer medium, such as, for example, salts of moderately strong bases and weak acids, such as, in particular, ammonium acetate.

In one further preferred embodiment of the invention the coating composition K2 comprises at least one component KOS which reduces the surface tension of the coating composition of the invention during autophoretic deposition on the substrate surface and/or during the subsequent drying step.

The component KOS may be chosen from the group of the anionic, cationic, and nonionic surface-active substances. Amphiphilic substances are used with preference, and may be of low molecular weight, oligomeric and/or polymeric. By “amphiphilic” is meant that the substances have a hydrophilic and a hydrophobic structural component. By “(of) low molecular weight” is meant that the average molecular weights of the surface-active component KOS are up to 2000 daltons, more preferably up to 1000 daltons; by “oligomeric” is meant that the surface-active component KOS has about 2 to 30, preferably 3 to 15, preferably repeating, units and an average molecular weight of between about 200 and 4000 daltons, preferably between about 500 and 3000 daltons, and by “polymeric” is meant that the surface-active component KOS has more than 10, preferably repeating, units and an average molecular weight of more than 500 daltons, preferably more than 1000 daltons. The surface-active component KOS is different than the polymer P of the invention.

As surface-active components KOS it is preferred to use, as low molecular weight substances, alkylcarboxylic acids and their salts, alpha,omega-dicarboxylic acids and their salts, alpha,omega-dialcohols, alpha,omega-diamines, and alpha,omega-amides, and also their salts, alkylsulfonic acids and their salts, and also alkylphosphoric acids and alkylphosphonic acids and their salts. As oligomeric and/or polymeric surface-active substances it is preferred to use polyalkylene glycols, polyvinyl lactams, such as polyvinylpyrrolidone and polyvinylcaprolactam, for example, polyvinylimidazoles, polyvinyl alcohols, and polyvinyl acetate. Especially preferred surface-active components KOS used are, as low molecular weight substances, adipic acid and/or 1,6-hexanediol and, as oligomeric and/or polymeric substances, poly(oligo)ethylene glycols and/or poly(oligo)propylene glycols.

The fraction of the surface-active substance KOS as a proportion of the coating composition K2 is preferably between 10⁻⁴% and 5% by weight, more preferably between 10⁻²% and 2% by weight, based on the coating composition K2.

In one particularly preferred embodiment of the invention the coating composition K2 further comprises a salt (S) which as its cationic constituent comprises lanthanide metal cations and/or d-block metal cations.

Preferred lanthanide metal cations are lanthanum, cerium, praseodymium, neodymium, promethium, samarium, europium and/or dysprosium cations. Lanthanum, cerium, and praseodymium cations are especially preferred. The lanthanide metal cations may be present in a monovalent, divalent and/or trivalent oxidation state, the trivalent oxidation state being preferred. Preferred d-block metal cations are titanium, vanadium, manganese, yttrium, zirconium, niobium, molybdenum, tungsten, cobalt, ruthenium, rhodium, palladium, osmium and/or iridium cations. Barred from consideration as a d-block element cation is the chromium cation, in any oxidation state. Vanadium, manganese, tungsten, molybdenum and/or yttrium cations are especially preferred. The d-block element cations may be present in a mono- to hexavalent oxidation state, preference being given to a trivalent to hexavalent oxidation state.

In one especially preferred embodiment of the invention the lanthanide metal cations and/or d-block element cations of the salt (S) may also take the form of complexes with unidentate and/or multidentate, potentially anionic ligands. Preferred ligands are unfunctionalized or functionalized terpyridines, unfunctionalized or functionalized ureas and/or thioureas, unfunctionalized or functionalized amines and/or polyamines, such as EDTA in particular, imines, such as imine-functionalized pyridines in particular, organosulfur compounds, such as, in particular, unfunctionalized or functionalized thiols, thiocarboxylic acids, thioaldehydes, thioketones, dithiocarbamates, sulfonamides, thioamides, and, with particular preference, sulfonates, unfunctionalized or functionalized organoboron compounds, such as boric esters in particular, unfunctionalized or functionalized polyalcohols, such as, in particular, carbohydrates and their derivatives and also chitosans, unfunctionalized or functionalized acids, such as, in particular, difunctional and/or oligofunctional acids, unfunctionalized or functionalized carbenes, acetylacetonates, unfunctionalized or functionalized acetylenes, unfunctionalized or functionalized carboxylic acids, such as, in particular, carboxylic acids which can be attached ionically and/or coordinatively to metal centers, and also phytic acid and derivatives thereof.

In the preferred second step (II) of the process the substrates coated with the anticorrosion agent K1 are coated with the coating composition K2. Before the anticorrosion agent K2 is applied, the substrate coated with the anticorrosion agent K1 can be dried or flashed off as described above. Coating with the anticorrosion agent K2 preferably follows on directly from coating with the anticorrosion agent K1, the application of the anticorrosion agent K1 being followed preferably by rinsing with, preferably, distilled water and by blow-drying with air, preferably with an inert gas, as for example with nitrogen. Coating takes place preferably by immersing or drawing the coated substrate in or through a bath containing the coating composition K2. The residence times of the substrate in the coating composition K2 are preferably 1 second to 15 minutes, more preferably 10 seconds to 10 minutes and with particular preference 30 seconds to 8 minutes. The temperature of the bath containing the coating composition of the invention is preferably between 20 and 90° C., more preferably between 25 and 80° C., with particular preference between 30 and 70° C.

The wet film thickness of the coat produced with the coating composition K2, after autophoretic application, is between 5 and 1500 nm, preferably between 15 and 1250 nm, more preferably between 25 and 1000 nm.

After the substrate has been treated with the coating composition K2, before the concluding electrodeposition coating, the system composed of substrate and the coats of the coating composition K1 and of the coating composition K2 may be dried at temperatures between about 30 to 200° C., in particular between 100 and 180° C., for which the drying apparatus can be regarded as largely uncritical to the advantageous action of the coating composition of the invention. With very particular preference the system made up of coating composition K1 and coating composition K2 is flashed off prior to the concluding electrodeposition coating—in other words, it is exposed to temperatures between 25 and 120° C., preferably between 30 and 90° C., for a period of 30 seconds to 30 minutes, preferably for a period of 1 minute to 25 minutes.

### The Concluding Electrodeposition Coating (III) of the Coating Process of the Invention

Suitable in principle for the electrodeposition coating carried out in stage (III) are all cathodically depositable electrocoat materials. It is preferred to use cathodically depositable electrocoat materials which meet exacting environmental standards, such as, in particular, electrocoat materials that are free from lead or chromium anticorrosion pigments, such coating materials being described in EP-A-0 528 853, for example.

As binders for the cathodically depositable electrocoat materials it is preferred to use amine-modified epoxy resins in combination with crosslinkers, of the kind described for example in DE-A-35 18 770, DE-A-35 18 732, EP-A-0 102 501, DE-A-27 01 002, U.S. Pat. No. 4,104,147, EP-A-0 004 090, EP-A-0 012 463, U.S. Pat. No. 4,031,050, U.S. Pat. No. 3,922,253, U.S. Pat. No. 4,101,486, U.S. Pat. No. 4,038,232, and U.S. Pat. No. 4,017,438.

The electrocoat materials can be applied without problems to the coats deposited in stage (I) and/or stage (II). The parameters for the electrophoretic deposition of the electrodeposition coatings correspond to the technologically commonplace parameters.

The layer systems produced in the sequence stages (I) and (III) or of stages (I), (II), and (III) are baked generally at temperatures of 130 to 200° C., preferably at temperatures of 150 to 180° C., for a period of 15 to 60 minutes, preferably for a period of 15 to 30 minutes. This baking is accompanied by intense crosslinking of the electrocoat film applied in stage (III) and of the film of coating composition K2 applied in the preferred stage (II).

Surprisingly the electrocoat adheres outstandingly to the coats deposited in stage (I) or stage (II). Moreover, the resistance of the layer systems to impact stress is outstanding.

The resistance to corrosion is excellent, and meets the requirements of automotive engineering to a high degree.

Atop the coat applied in stage (III) it is possible to apply in particular the coats that are typical of automotive OEM finishing, in the sequence of surfacer, basecoat, and clearcoat, in processes which are known per se.

The process of the invention can be applied, surprisingly, to a broad spectrum of substrates and is largely independent of the substrate's redox potential.

Preferred substrate materials are zinc, iron, magnesium, and aluminum, and their alloys, the aforementioned metals being present preferably to at least 20% by weight in the alloys. The substrates have preferably been shaped into metal panels, of the kind employed for example in the automobile industry, the construction industry, and the mechanical engineering industry.

The examples given below are intended to provide further illustration of the invention.

### EXAMPLES

### Preparation Example 1a

### Preparation of the First Tank, Containing the Anticorrosion Agent K1

1.77 g (0.01 mol) of ammonium molybdate tetrahydrate (A1) are dissolved in one liter of water. The solution is adjusted using nitric acid (A2) to a pH=2.5. Where appropriate, counterbuffering with aqueous ammonia solution is used to set the aforementioned pH.

### Preparation Example 2a

### Synthesis of the Polymer Component P for the Anticorrosion Agent K2

5 g (6.25*10⁻³ mol) of a polyethyleneimine having an average molecular weight Mw=800 g/mol (Lupasol FG from BASF AG, ratio of primary:secondary:tertiary amino groups (p-s-t): 1:0.9:0.5) are introduced as an initial charge in 100 g of ethanol under a nitrogen atmosphere, and 10.7 g (0.066 mol) of benzoyl isothiocyanate in solution in 86 g of ethanol are added at 75° C. over the course of 45 minutes. The mixture is left at this temperature with stirring for 4 h and the product is used without further purification.

### Preparation Example 2b

### Synthesis of the Crosslinker V Containing the Salt S for the Anticorrosion Agent K2

3.1 g (0.008 mol) of cerium(III) chloride heptahydrate in 50 ml of water are introduced as an initial charge. A solution is prepared from 4.1 g (0.025 mol) of 4-hydroxycinnamic acid and 1 g (0.025 mol) of aqueous sodium hydroxide solution in 50 ml of water and is brought using hydrochloric acid to a pH=7.9. This solution is added slowly to the cerium solution at a rate such that the pH of the cerium solution does not rise above 6. The precipitate is washed with ethanol and water. 1.7 g (0.003 mol) of this cerium complex are reacted together with 9.1 g (2.5% NCO content) of a branched polyisocyanate with 75% dimethylpyrazole blocking (Bayhydur VP LS 2319 from Bayer AG) in 80.1 g of ethyl acetate and 0.7 g of an OH-functional dipropylenetriamine (Jeffcat ZR 50 from Huntsman) at 40° C. for five hours. The product is used without further purification.

### Preparation Example 3

### Preparation of the Second Tank, Containing the Anticorrosion Agent K2

3 g of the polymer component P of Example 2a and 2 g of the crosslinker V of Example 2b are dissolved in one liter of water. The solution is adjusted using nitric acid to a pH=2.5. Where appropriate, counterbuffering with aqueous ammonia solution is used to set the aforementioned pH.

### Example 4

### Coating of the Substrate with Anticorrosion Agent K1 (Stage I) and Anticorrosion Agent K2 (Stage II)

The substrate (panel of galvanized steel) is cleaned in a cleaning solution (Ridoline C72 from Henkel) at 55° C. for 5 minutes and thereafter is rinsed with distilled water.

Subsequently the metal panel, rinsed with distilled water, is immersed immediately at 45° C. for 4 minutes into the first tank of the anticorrosion agent K1 of Example 1a. Thereafter the coated panel is rinsed off with distilled water and blown dry using nitrogen.

Immediately thereafter the panels are immersed at 35° C. for 5 minutes into the second tank of the anticorrosion agent of the invention, of Example 3a. A coat is formed which is invisible to opalescent in the λ/4 region of visible light. Thereafter the coated panel is rinsed with distilled water and blown dry using nitrogen.

The panel is subsequently flashed off at 80° C. for 2.5 minutes.

### Example 5

### Coating of the Metal Panel, Coated in Example 4, with a Cathodic Electrocoat Material (Stage III)

The metal panel coated and conditioned in Example 4 is coated with a commercial lead-free cathodic electrocoat material (Cathoguard® 500 from BASF Coatings AG) at a bath temperature of 32° C. and a deposition time of 120 seconds and is subsequently cured at 175° C. for 20 minutes. The thickness of the deposited and cured coat of cathodic electrocoat material is 19 to 20 μm.

As a reference, a metal panel coated with a commercial phosphating agent (Gardobond 26S W42 MBZE3 from Chemetall) is likewise coated with the above-recited lead-free electrocoat material under the conditions recited above, and cured. The thickness of the deposited and cured coat of cathodic electrocoat material is likewise 19 to 20 μm.

### Example 6

### Accelerated Corrosion Test Using Harrison Solution on the Substrates Coated in Example 5

A Harrison solution (5 g NaCl+35 g (NH₄)₂SO₄) in 1000 ml of fully demineralized water is used. Substrates utilized here may be steel, galvanized steel or zinc alloys. Adhered to the surface of the specimens (6*6 cm) coated with the coat elucidated above is a plastic cylinder having a diameter of 48 mm and a height of 6 cm, the adhesive used being transparent Scrintec 600 silicone adhesive, RTV 1 k oxime system (from Ralicks, 46459 Rees). 70 ml of Harrison solution are introduced in this cylinder. Using these samples, an electrochemical impedence measurement (EIS) is carried out in a 2-electrode setup from 1 MHz to 100 mHz, with an amplitude of 1 mV and open potential, using a platinum mesh as the reference electrode.

The samples prepared in this way are weathered in a temperature range of 25° C. to 73° C. for a total of 20 cycles such that in each case the maximum and the minimum temperatures are crossed within an hour. After this, the cylinder, which is now dry, is again filled with 30 ml of Harrison solution, and after a residence time of 10 minutes this solution is used for the determination of any ions dissolved in the course of weathering, by means of ICP-OES (Inductively Coupled Plasma—Optical Emission Spectrometry). After that a further 70 ml of Harrison solution are introduced into the cylinder and a further EIS measurement is carried out. The EIS measurement is followed again by weathering, by means of the accelerated test, after which, once again, an ICP-OES sample is taken and a further EIS measurement performed. The measurement is verified by a duplicate determination.

### Evaluation of the Corrosion Test:

### a) ICP-OES Data of the Immersion Solution

The ICP-OES data are standardized for the area of the samples. These data produce a linear plot. On the basis of the linearity of the corrosion kinetics, the different coatings can be compared by means of the slopes of the graph. The ICP-OES data show the resolution of the substrate per unit area and per unit time, and are therefore a direct measure of the corrosion rate possible for a particular coating.

b) EIS measurements

The EIS measurements may likewise be employed for measuring the corrosion kinetics. As a result of measurement at the defect site, that site is detected electrochemically, i.e., the oxide layer of the substrate is determined. Subject to the proviso that, under identical weathering conditions, identical oxide growth can be expected, the capacitance, in accordance with:

$$C = \frac{{ɛ}_{0} {ɛ}_{R} A}{d}$$

represents a measure of the area of the exposed substrate, which in turn is a measure of the corrosion rate. The higher the capacitance or its square root, the greater the corrosion rate.

The square root of this capacitance exhibits an approximately linear correlation with the reciprocal sub-film migration in a VDA-KWT test, so that these values can be employed as a measure of the corrosion control.

### Evaluation of the Corrosion Test:

Results of the corrosion test

| Substrate | Square root of the capacitance |
|---|---|
| Galvanized steel panel | 0.00172 |
| Phosphating 26S W42 MBZE3 | |
| (Chemetall) and Cathoguard ® 500 | |
| Galvanized steel panel | 0.00163 |
| coated as per Example 4 | |
| and Cathoguard ® 500 | |

The results of the corrosion tests show the improvement in corrosion control through the coating composition of the invention as compared with a commercial anticorrosion agent (phosphating).

1. A process for corrosion-proofing a metallic substrate, comprising
(I) coating in a first stage a substrate by electroless immersion into an aqueous bath of an anticorrosion agent K1 with a pH of between 1 and 5, comprising at least
(A1) one compound having as its cation a lanthanide metal and/or a d-block element metal, bar chromium, and/or having as its anion a d-block element metallate, bar chromium-containing metallates, and
(A2) at least one oxidation-capable acid, bar phosphorus and/or chromium acids, such that a conversion is effect on a surface of the substrate, and
(III) depositing a cathodic electrocoat material to the coated substrate in a concluding stage.

2. The process of claim 1, wherein the compound (A1) containing lanthanide metal and/or d-block element cations comprises at least one component which is selected from the group consisting of anions of oxidizing acids of the elements of transition groups VI, VII, and VIII, anions of oxidizing acids of the elements of main groups V and VI of the periodic table of the elements, bar anions of phosphorus and/or chromium acids, the halides, bar fluoride, and potentially anionic, complexing, unidentate and/or multidentate ligands.

3. The process of claim 2, wherein at least one component of the compound (A1) is a d-block element metallate comprising at least one member selected from the group consisting of tungstate, permanganate, vanadate, molybdate and combinations thereof.

4. The process of claim 1, wherein the acid (A2) comprises at least one member selected from the group consisting of nitric acid, nitrous acid, sulfuric acid, sulfurous acid, and combinations thereof.

5. The process of claim 1, further comprising a coating stage (II) between stage (I) and concluding stage (III), the coating stage (II) comprising immersing the coated substrate electrolessly into a bath of an aqueous anticorrosion agent K2, K2 comprising at least one water-dispersible and/or water-soluble polymer P with covalently attached ligands L that form chelates with the substrate surface and/or with the metal ions liberated in the course of the corrosion of the substrate, and also having crosslinking functional groups B which are able to form covalent bonds to crosslinkers V with themselves and/or with further complementary functional groups B′ of the polymer P and/or of the crosslinkers V.

6. The process of claim 5, wherein the aqueous anticorrosion agent K2 further comprises a salt (S) containing as its cationic constituent lanthanide metal cations and/or d-block metal cations.

7. The process of claim 6, wherein the lanthanide metal cations and/or d-block metal cations of the salt (S) are present in the form of complexes with unidentate and/or multidentate ligands.

8. The process of claim 5, comprising crosslinkers V comprising covalently bonded ligands L′.

9. The process of claim 5, comprising ligands L comprising at least one member selected from the group consisting of ureas, amines, amides, imines, imides, pyridines, organosulfur compounds, organophosphorus compounds, organoboron compounds, oximes, acetylacetonates, polyalcohols, acids, including phytic acids, acetylenes, carbenes, and combinations thereof.

10. The process of claim 5, comprising a polymer P comprising a polymer backbone comprising one or more units selected from the group consisting of polyesters, polyacrylates, polyurethanes, polyolefins, polyalcohols, polyvinyl ethers, polyvinylamines, and polyalkyleneimine.

11. The process of claim 1, further comprising immersing the substrate in the aqueous bath of anticorrosion agent in stage (I) for a residence time of the substrate in the aqueous bath of between 1 second to 10 minutes, wherein the temperature of the aqueous bath containing anticorrosion agent K1 is between 25 and 90° C.

12. The process of claim 5, further comprising immersing the coated substrate in the aqueous bath of anticorrosion agent K2 in stage (II) for a residence time of between 1 second to 15 minutes, wherein the temperature of the aqueous bath containing anticorrosion agent K2 is between 25 and 90° C.

13. The process of claim 5, wherein stage (II) produces a coat with the coating composition K2, after autophoretic application, that has a thickness of between 5 and 1500 nm.

14. The process of claim 1, further comprising exposing the coat of coating composition K1 in stage (I) to temperatures of between 25 and 120° C. for a period of 30 seconds to 30 minutes prior to the concluding stage (III).

15. The process of claim 1, wherein stage (I) with the coating composition K1, after autophoretic application, produces a coat having a thickness of between 5 and 900 nm.

16. The process of claim 5, further comprising expositing the system of coating composition K1 and coating composition K2 to temperatures of between 25 and 120° C. for a period of 30 seconds to 30 minutes prior to the concluding stage (III).

17. The process of claim 1, further comprising exposing an applied electrocoat to temperatures of from 120 to 200° C. for a period of from 15 to 60 minutes.

18. The process of claim 1, wherein at least one surface to be coated of the substrate comprises at least 20% by weight of a metal selected from the group consisting of Fe, Al and/or Zn.
